(19) United States
(12) Patent Application Publication
(10) Pub. No.: US 2003/0056963 A1
(43) Pub. Date: Mar. 27, 2003

(54) Apparatus for controlling a downhole drilling motor assembly

(76) Inventor: Wiliam Ray Wenzel, Edmonton (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/260,637

(22) Filed: Sep. 27, 2002

(30) Foreign Application Priority Data
Sep. 27, 2001 (CA) 2,357,999

(51) Int. Cl. B25D 11/00

(52) U.S. Cl. 173/128

(57) ABSTRACT

An apparatus for controlling a downhole drilling motor assembly includes a tubular housing having an interior sidewall which defines an interior bore. A mandrel is rotatably mounted within the interior bore of the housing. The mandrel has an exterior surface. A hydraulic dampener assembly is disposed between the interior sidewall of the housing and the exterior surface of the mandrel. The hydraulic dampener assembly limits the rate of rotation of the mandrel within the housing, thereby providing a preset resistance to reactive torque. The described apparatus can also be used as a steering tool by the addition of a feature that selectively blocks the flow of hydraulic fluids through the hydraulic dampener, thereby locking the mandrel in a selected directional position.

### FIELD OF THE INVENTION

The present invention relates to an apparatus for controlling a downhole drilling motor assembly

### BACKGROUND OF THE INVENTION

A downhole drilling motor assembly always includes a downhole drilling motor and may include other components, as will hereinafter be further described. Regardless of the components included in the assembly, the downhole drilling motor is always subject to reactive torque. The amount of reactive torque experienced varies with the type of formation that is encountered when drilling. Sand provides a relatively low amount of reactive torque. A rock formation provides a relatively high amount of reactive torque. Passing from zones of relatively low reactive torque to relatively high reactive torque or vis-a-versa tends to be hard on the downhole drilling motor assembly.

### SUMMARY OF THE INVENTION

What is required is an apparatus for controlling a downhole drilling motor assembly which has among its features a capability of reducing the damaging effects of variations in reactive torque.

According to the present invention there is provided an apparatus for controlling a downhole drilling motor assembly, which includes a tubular housing having an interior sidewall which defines an interior bore. A mandrel is rotatably mounted within the interior bore of the housing. The mandrel has an exterior surface. A hydraulic dampener assembly is disposed between the interior sidewall of the housing and the exterior surface of the mandrel. The hydraulic dampener assembly limits the rate of rotation of the mandrel within the housing, thereby providing a preset resistance to reactive torque,

The apparatus, as described above, uses hydraulics to limit the rate of rotation of the mandrel within the housing. This protects the downhole drilling motor assembly from variations in reactive torque. It can also be used to adjust the drilling speed of the downhole drilling motor assembly. This is done by permitting a selected amount of reactive torque. If the drilling speed is to be decreased in order to prolong the life of the drill bit, the amount of reactive torque permitted by the apparatus is increased. If the drilling speed is to be increased, the amount of reactive torque permitted by the apparatus is decreased. Adjustments are made to the reactive torque permitted by the apparatus by altering the viscosity of the hydraulic fluid used. The more viscose the hydraulic fluid, the more slowly the hydraulic fluid will flow through the hydraulic dampener to enable the mandrel to rotate. The less viscose the hydraulic fluid, the more rapidly the hydraulic fluid will flow through the hydraulic dampener to enable the mandrel to rotate.

Once the teachings of the present invention are understood, there may be alternative configurations of hydraulic dampener which could be developed by one skilled in the art. The preferred form of hydraulic dampener which is hereinafter illustrated and described includes an annular body having a sidewall, a first end, a second end, an interior surface and an exterior surface. A splined engagement is provided between the interior surface of the annular body and the exterior surface of the mandrel. This causes the annular body to rotate with the mandrel while enabling limited axial movement of the annular body along the mandrel. A guide track is provided on the exterior surface which encircles the annular body. The guide track alternatively extends in a first direction from the first end toward the second end of the annular body and then in a second direction from the second end toward the first end of the annular body in a zig-zag pattern. Several guide members extend inwardly into the interior bore from the interior surface of the housing. The guide members engage the guide track on the annular body. This limits rotational movement of the annular body relative to the housing to the zig-zag pattern provided by the guide track. It is preferred that the guide members terminate in balls, as this reduces friction between the guide members and the guide track.

The movement of the annular body is dampened by hydraulics. At least one flow passage extends through the annular body. The annular body is only being able to move as hydraulic fluid is displaced via the flow passage. Movement of the annular body in the first direction occurring at a rate determined by the displacement of hydraulic fluid in the second direction and movement of the annular body in the second direction occurring at a rate determined by the displacement of hydraulic fluid in the first direction. One refinement is to use one way hydraulic valves. In accordance with this embodiment, a first series of one way hydraulic valves extend through the sidewall between first end and the second end of the annular body. Hydraulic fluid can only pass through the first series of one way hydraulic valves from the second end to the first end, such that movement in the first direction can only occur at a rate determined by the bleeding of hydraulic fluid through the first series of one way hydraulic valves. A second series of one way hydraulic valves extend through the sidewall between the first end and the second end of the annular body. Hydraulic fluid can only pass through the second series of hydraulic valves from the first end to the second end, such that movement in the second direction can only occur at a rate determined by the bleeding of hydraulic fluid through the second series of one way hydraulic valves.

Although beneficial results may be obtained through the use of the apparatus, as described above, further features may be desirable when the downhole drilling motor assembly includes a bent housing and a sonde housing, A bent housing, as the name implies, is a housing with a bend in it of between one and two degrees which is added to the downhole drilling motor assembly in order to permit a directional deviation to be achieved. A sonde housing is an electronics package which is added to the downhole drilling motor assembly to provide information on drill bit positioning, including information as to the positioning of the bend of the bent housing. When drilling a straight hole with a downhole drilling motor assembly, the bend of the bent housing is permitted to orbit the axis of the hole. In order to turn the downhole drilling motor assembly, the bend must be pointing in the direction the driller wishes to go and be held stationary. Increasingly, downhole drilling motor assemblies are being used with coil tubing. Although the sonde housing gives the driller an accurate indication of the positioning of the bend of the bent housing, it is difficult for the driller to point the bend in the desired direction and then maintain the bend in position while drilling. Even more beneficial results may, therefore, be obtained when means is provided to selectively block the flow of hydraulic fluid simultaneously through both the first series of one way hydraulic valves and the second series of one way hydraulic valves, thereby locking the mandrel in a selected rotational position relative to the housing. The manner in which the locking of the mandrel in a selected rotational position relative to the housing is effected may vary. There will hereinafter be described and illustrated an annular plug reciprocally movable along the mandrel between a locking position engaging one of the first end or the second end of the annular body and a release position spaced from the annular body. The movement of the annular plug between the locking position and the release position can be accomplished through a telescopic actuator. It is envisaged that the telescopic actuator will be powered by an electric motor which is controlled by the driller through a wireline connection. There will also be described an alternative embodiment in which an electrically activated valve communicating with the flow passage through which hydraulic fluid passes is used to selectively block flow. When the electrically activated valve is in an open position it allows a flow of hydraulic fluid through the flow passage. When the electrically activated valve is in a closed position it stops the flow of hydraulic fluid through the flow passage. Means is provided for selectively moving the electrically activated valve between the open position and the closed position.

Although beneficial results may be obtained through the use of the apparatus for controlling a downhole drilling motor assembly, as described above, it is preferred that the electrically activated valve not be subject to movement with the annular body. If a wire which makes an electrical connection is subjected to constant movement, the wire tends to fatigue. Even more beneficial results may, therefore, be obtained when the electrically activated valve is mounted on a stationary flow restricting member. This flow restricting member is spaced from one of the first end or the second end of the annular body and blocks the movement of hydraulic fluid within the hydraulic chamber. The hydraulic fluid trapped between the annular body and the flow restricting member prevents movement of the annular body until the electrically activated valve is in the open position. In this manner the electrically activated valve can control flow through the annular body, without moving with the annular body.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of an apparatus for controlling a downhole drilling motor assembly in accordance with the teachings of the present invention.

FIG. 2 is a detailed side elevation view, in section, of the apparatus illustrated in FIG. 1.

FIG. 3 is a detailed side elevation view, in section, of the apparatus illustrated in FIG. 1, with annular plug in a locked position.

FIG. 4 is a detailed side elevation view, in section of the apparatus illustrated in FIG. 1 with annular plug in a release position.

FIG. 5 is a perspective view an annular body with a guide track.

FIG. 6 is a side elevation view of a downhole drilling motor assembly which includes a bent housing and a sonde housing.

FIG. 7 is a detailed side elevation view, in section, of an alternative form of hydraulic dampener assembly, in a locked position.

FIG. 8 is a detailed side elevation view, in section, of the alternative form of hydraulic dampener assembly illustrated in FIG. 7, in a release position.

FIG. 9 is a perspective view an annular body with a guide track, from the alternative form of hydraulic dampener assembly illustrated in FIG. 7.

FIG. 10 is an end elevation view of a clutch which engages an end of the annular body illustrated in FIG. 9.

FIG. 11 is a detailed side elevation view, in section, of a second alternative form of hydraulic dampener assembly in with an electrically activated valve.

FIG. 12 is a perspective view of an annular body with several guide tracks, from the second alternative form of hydraulic dampener assembly illustrated in FIG. 11.

FIG. 13 is a detailed side elevation view, in section, of the second alternative form of hydraulic dampener assembly illustrated in FIG. 11, with an independent power source.

### DETAILED DESCRIPTION OF THE PREFERRED EMBODIMENT

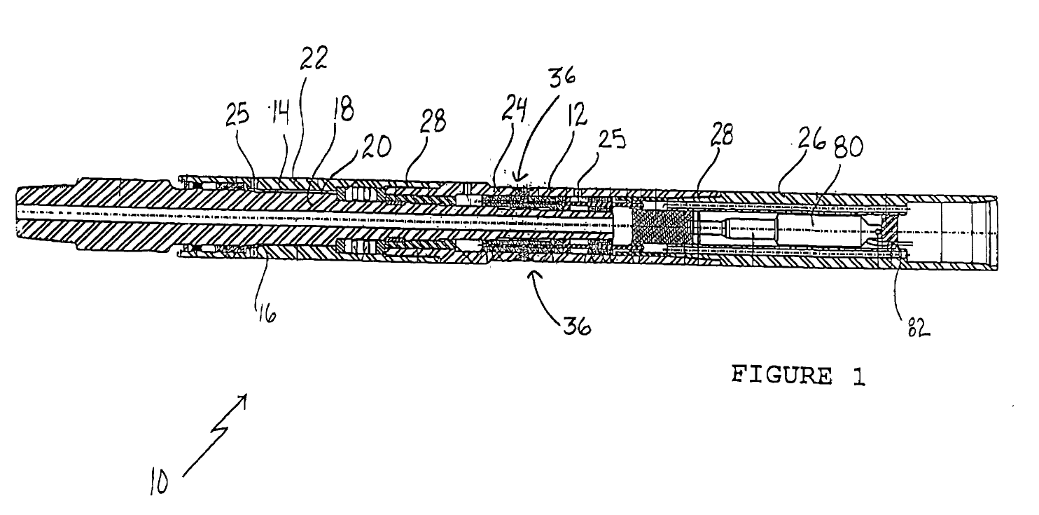

The preferred embodiment, an apparatus for controlling a downhole drilling motor assembly generally identified by reference numeral 10, will now be described with reference to FIGS. 1 through 6.

Structure and Relationship of Parts:

Referring to FIG. 1, apparatus 10 which includes a tubular housing 12 with an interior sidewall 14 which defines an interior bore 16. A mandrel 18 is rotatably mounted within interior bore 16 of housing 12. Mandrel 18 has an exterior surface 20. For ease of assembly, housing 12 has a first section 22, a second section 24 and a third section 26 with joints 28 provided between first section 22 and second section 24 and between second section 24 and third section 26. Grease ports 25 are positioned along tubular housing 12, in order to add oil, grease or other hydraulic fluids after assembly.

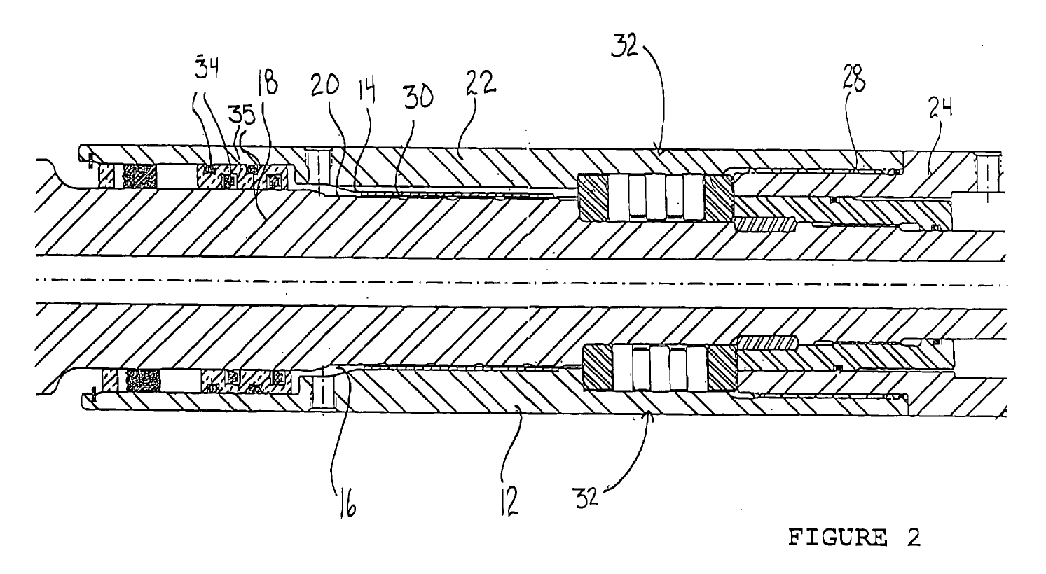

Referring to FIG. 2, radial bearings 30 are disposed between interior sidewall 14 of housing 12 and exterior surface 20 of mandrel 18, thereby transmitting radial loads from mandrel 18 to housing 12. Thrust bearings, generally referenced by numeral 32, are disposed between interior sidewall 14 of housing 12 and exterior surface 20 of mandrel 18, thereby transmitting axial thrust loads from mandrel 18 to housing 12. Seals 34 are positioned in grooves 35 between interior sidewall 14 of housing 12 and exterior surface 20 of mandrel 18 to prevent the entry of abrasive drilling fluids into radial bearings 30 and thrust bearings 32.

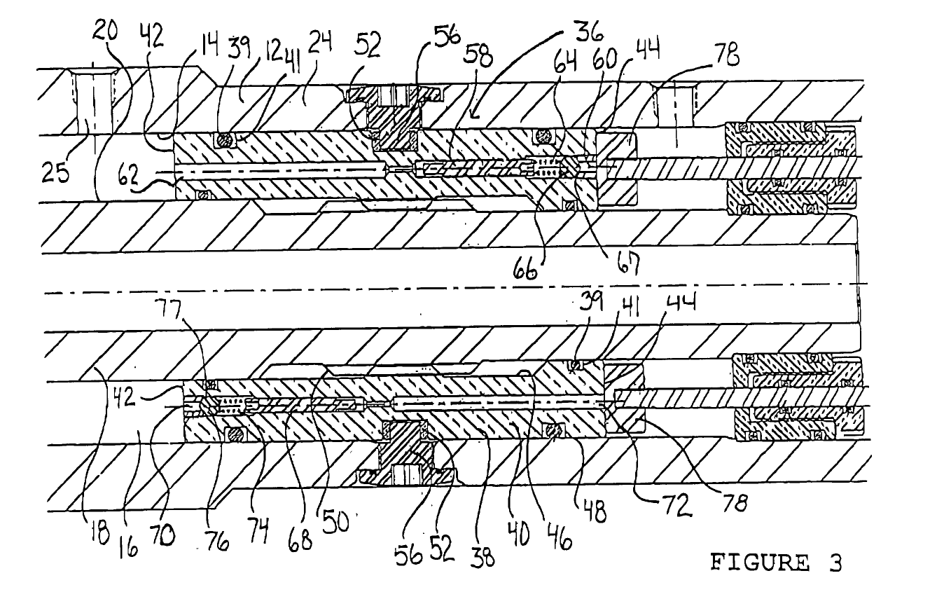

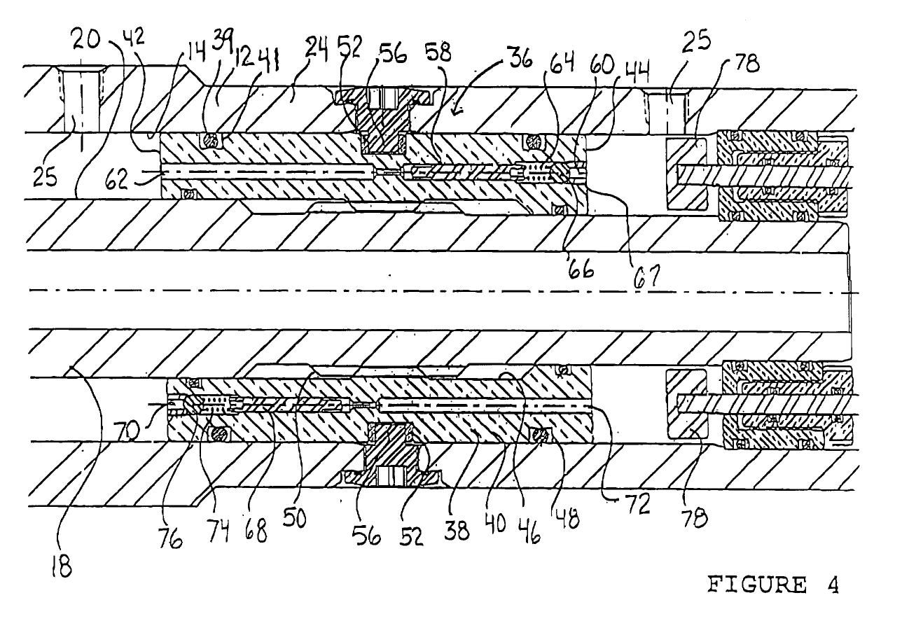

Referring to FIGS. 3 and 4, a hydraulic dampener assembly, generally referenced by numeral 36, is disposed between interior sidewall 14 of housing 12 and exterior surface 20 of mandrel 18. Hydraulic dampener assembly 36 includes an annular body 38 that has a sidewall 40, a first end 42, a second end 44, an interior surface 46 and an exterior surface 48. There is a splined engagement 50 between interior surface 46 of annular body 38 and exterior surface 20 of mandrel 18, such that annular body 38 rotates with mandrel 18 while being capable of limited axial movement along mandrel 18. Seals 39 are positioned in grooves 41 along interior surface 46 and exterior surface 48 of sidewall 40 of annular body 38 to prevent fluids from bypassing hydraulic dampener assembly 36.

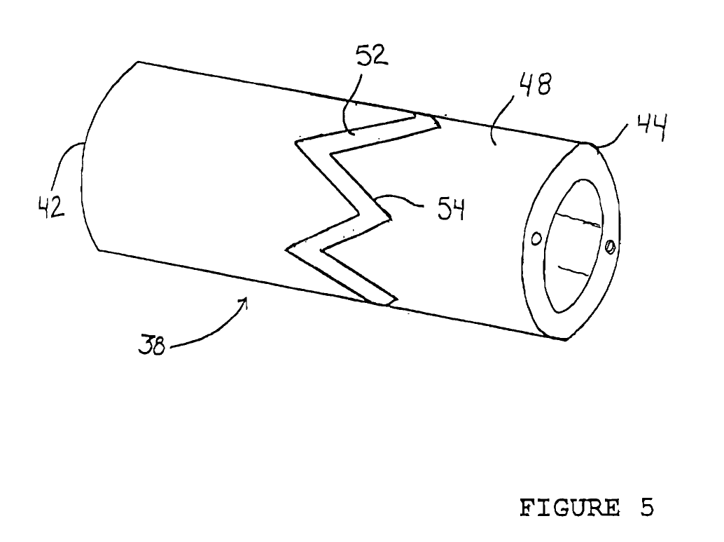

Referring to FIG. 5, exterior surface 48 of annular body 30 has a guide track 52 which encircles annular body 38. Guide track 52 alternatively extends in a first direction from first end 42 toward second end 44 of annular body 38 and then in a second direction from second end 44 toward first end 42 of annular body 38 in a zig-zag pattern 54.

Referring to FIGS. 3 and 4, several guide members 56 extend inwardly into interior bore 16 from interior sidewall 14 of housing 12. Guide members 56 engage with guide track 52 on annular body 38, thereby limiting rotational movement of annular body 38 relative to housing 12 to zig-zag pattern 54 provided by guide track 52.

A first series of one way hydraulic valves 58 extend through sidewall 40 between first end 42 and second end 44 of annular body 38 through which hydraulic fluid can only pass from second end 44 to first end 42, such that movement in the first direction can only occur at a rate determined by the bleeding of hydraulic fluid through first series of one way hydraulic valves 58. First series of one way hydraulic valves 58 has a fluid inlet 60 and a fluid outlet 62. A spring 64 operates to bias a ball 66 into sealing engagement with fluid inlet 60. Fluid enters inlet 60 by overcoming the biasing force of spring 64 to move past ball 66. Fluid cannot, however, exit inlet 60 as fluid pushes ball 66 into sealing engagement with ball seat 67.

A second series of one way hydraulic valves 68 extends through sidewall 40 between first end 42 and second end 44 of annular body 38 through which hydraulic fluid can only pass from first end 42 to second end 44, ouch that movement in the second direction can only occur at a rate determined by the bleeding of hydraulic fluid through second series of one way hydraulic valves 68. Second series of one way hydraulic valves 68 has a fluid inlet 70 and fluid outlet 72. A spring 74 operates to bias a ball 76 into sealing engagement with fluid outlet 72. Fluid enters inlet 70 by overcoming the biasing force of spring 74 to move past ball 76. Fluid cannot, however, exit inlet 70 as fluid pushes ball 76 into sealing engagement with ball seat 77.

An annular plug 78 is reciprocally movable along mandrel 18 between a locking position illustrated in FIG. 3 and a release position illustrated in FIG. 4. Referring to FIG. 3, in the locking position, annular plug 78 engages second end 44 of annular body 38 so that annular plug 78 blocks the flow of hydraulic fluid simultaneously through both first series of one way hydraulic valves 58 and second series of one way hydraulic valves 68, thereby locking mandrel 18 in a selected rotational position relative to housing 12. Referring to FIG. 4, in the release position, annular plug 78 is spaced from annular body 38 whereby the flow of hydraulic fluid is permitted through both first series of one way hydraulic valves 58 and second series of one way hydraulic valve 68.

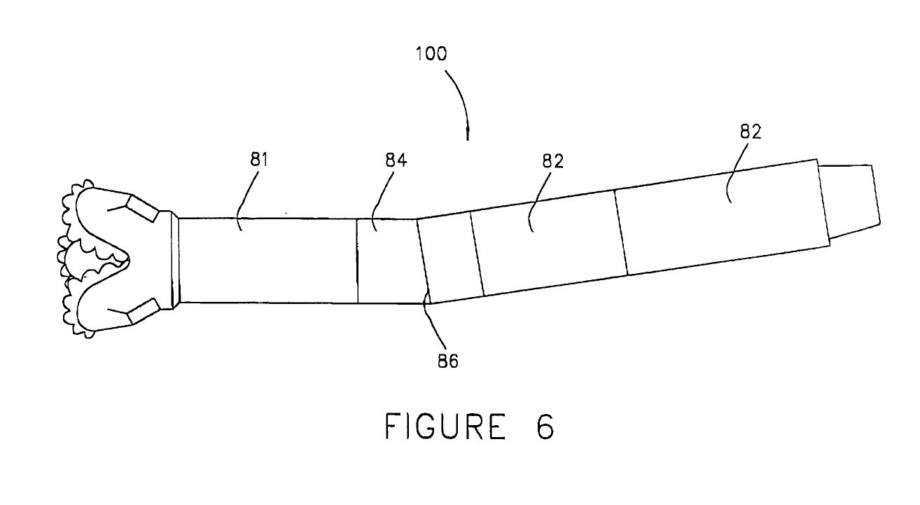

Referring to FIG. 1, a telescopic actuator 80 is disposed in housing 12. Telescopic actuator 80 is adapted to selectively move annular plug 78 between the release position and the locking position. Telescopic actuator 80 has an internal electric motor. A wireline connection 82 for selectively providing power to extend or retract telescopic actuator 80 as desired by the driller operating controls on surface. Referring to FIG. 6, apparatus 10 is intended to be connected to a downhole drilling motor assembly, generally indicated by reference numeral 100 which includes has a downhole motor 81, a sonde housing 82 and a bent housing 84. Bent housing has a bend 86 in it of between one and two degrees.

Operation:

The use and operation of apparatus 10 a downhole drilling motor assembly 100 will now be described with reference to FIGS. 1 through 6.

Referring to FIG. 1, apparatus 10, as described above, uses hydraulic dampener assembly 36 to limit the rate of rotation of mandrel 18 within housing 12, to provide a preset resistance to reactive torque. Apparatus 10 can also be used to adjust the drilling speed by permitting a selected amount of reactive torque. If the drilling speed is to be decreased, the amount of reactive torque permitted by apparatus 10 is increased. If the drilling speed is to be increased, the amount of reactive torque permitted by apparatus 10 is decreased. All adjustments to reactive torque permitted by apparatus 10 are arranged in advance by selecting the viscosity of the hydraulic fluid used. The more viscose the hydraulic fluid, the more slowly the hydraulic fluid will flow through hydraulic dampener assembly 36 to enable mandrel 18 to rotate. The less viscose the hydraulic fluid, the more rapidly the hydraulic fluid will flow through hydraulic dampener assembly 36 to enable mandrel 18 to rotate.

Referring to FIGS. 3 and 4, as hydraulic fluid flows into first series of one way hydraulic valves 58 through fluid inlet 60, the pressure of incoming hydraulic fluid pushes against ball 66 to compresses spring 64, thereby moving ball 66 such that incoming hydraulic fluid can pass in through fluid inlet 60 but can not exit back through fluid inlet 60 as spring 64 biases ball 66 back against ball seat 67. Similarly, as hydraulic fluid flow into second series of one way hydraulic valves 68, the pressure of incoming hydraulic fluid pushes against ball 76 to compresses spring 74, thereby moving ball 76 such that incoming hydraulic fluid can pass in through fluid inlet 70 but can not exit back through fluid inlet 70 as spring 74 biases ball 76 back against ball seat 77.

It will be appreciated from the foregoing description, how apparatus 10 can be used to control reactive torque, as a downhole drilling motor assembly drills through different substrates. Apparatus 10 can also be used as a steering tool. Referring to FIG. 6, bend 86 in bent housing 84 permits a directional deviation to be achieved, so that drilling proceeds in the direction the driller wishes to go. Sonde housing 82 provides vital drilling information, including information as to the positioning of bend 86 of bent housing 84. When drilling in a straight line annular plug 78 is left in the release position, illustrated in FIG. 4. Mandrel 16 rotates at a rate of rotation permitted by hydraulic dampener 36 and bend 86 of bent housing 84 also moves in a rotary fashion. When annular plug 78 is moved to the locked position, illustrated in FIG. 3, mandrel 16 no longer rotates which means locks bent housing 84 with bend 86 in a particular position. Referring to FIGS. 1 and 6, when bent housing 84 is pointing in the desired direction, the driller activates telescopic actuator 80 to move annular plug 78 to the locking position to selectively block the flow of hydraulic fluid simultaneously through both first series of one way hydraulic valves 58 and second series of one way hydraulic valves 68, thereby locking mandrel 18 in a selected rotational position relative to housing 12 and bent housing 84 is maintained in position during drilling. By selectively moving annular plug 78 between the locked and released position, the driller is able to steer downhole drilling motor assembly 100 via apparatus 10.

Variations:

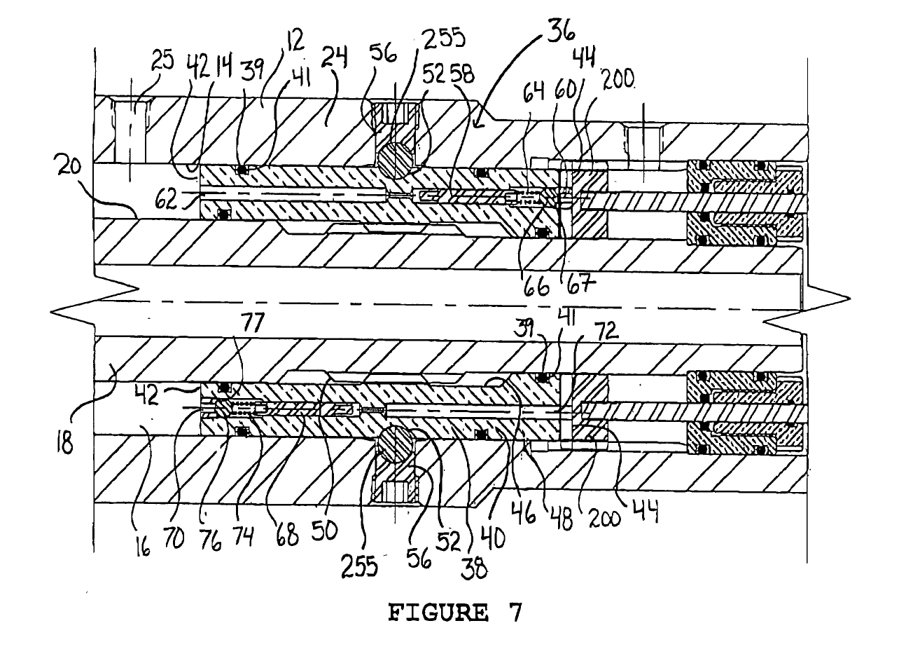

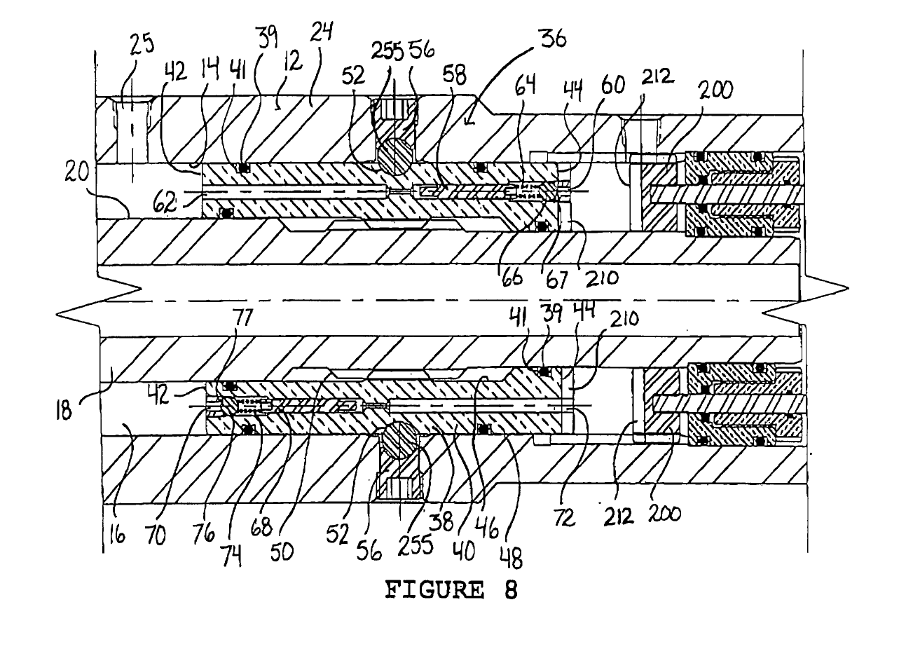

FIGS. 7 through 13 have been included to demonstrate variations that may be considered desirable. It would be undesirable if the guide members were to bind with the guide track. The operation of the hydraulic dampener requires the guide members to move along the guide track. Referring to FIGS. 7 and 8, a variation is illustrated in which guide members 56 terminate in balls 255, thereby reducing friction between guide members 56 and guide track 52. Balls 255 engage with guide track 52 on annular body 38, thereby limiting rotational movement of annular body 38 relative to housing 12 to zig-zag pattern 54 provided by guide track 52.

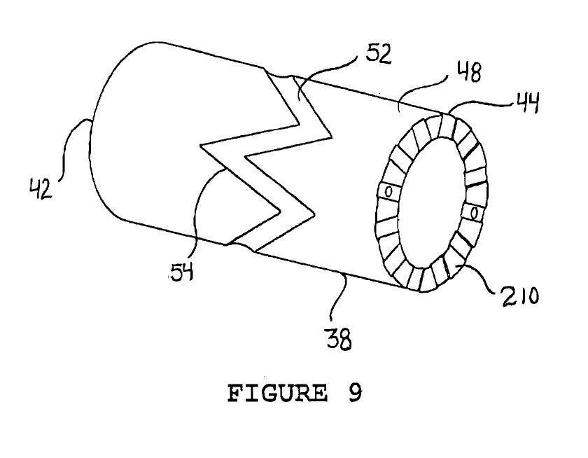

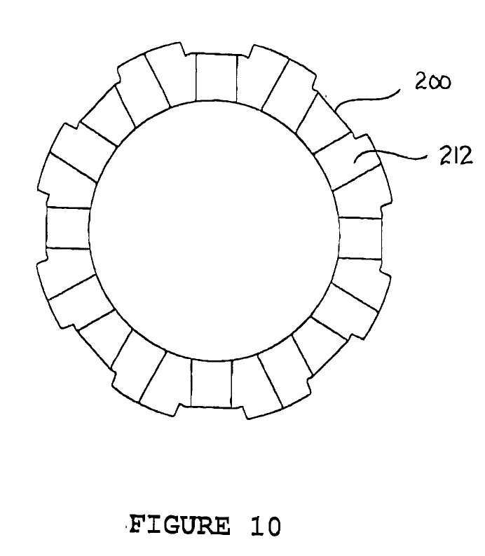

There are various means for locking the mandrel in a selected rotational position relative to the housing. One such means that is viewed as viable is the use of a clutch. Referring to FIGS. 7 through 10, there is illustrated the use of a clutch 200 as a locking mechanism. Clutch 200 is reciprocally movable along mandrel 18 between a locking position engaging second end 44 of annular body 38 as illustrated in FIG. 7 and a release position spaced from annular body 38, as illustrated in FIG. 8. Referring to FIG. 9, second end 44 of annular body 38 has a peripheral tooth profile 210. Referring to FIG. 10, clutch 200 also has peripheral tooth profile 212. Referring to FIG. 7, in the locking position, peripheral tooth profile 212 of clutch 200 engages peripheral tooth profile 210 at second end 44 of annular body 38, thereby locking mandrel 18 in a selected rotational position relative to housing 12. Referring to FIG. 8, in the release position, peripheral tooth profile 212 of clutch 200 is disengaged from peripheral tooth profile 210 at second end 44 of annular body 38, and clutch 200 is spaced from annular body 38.

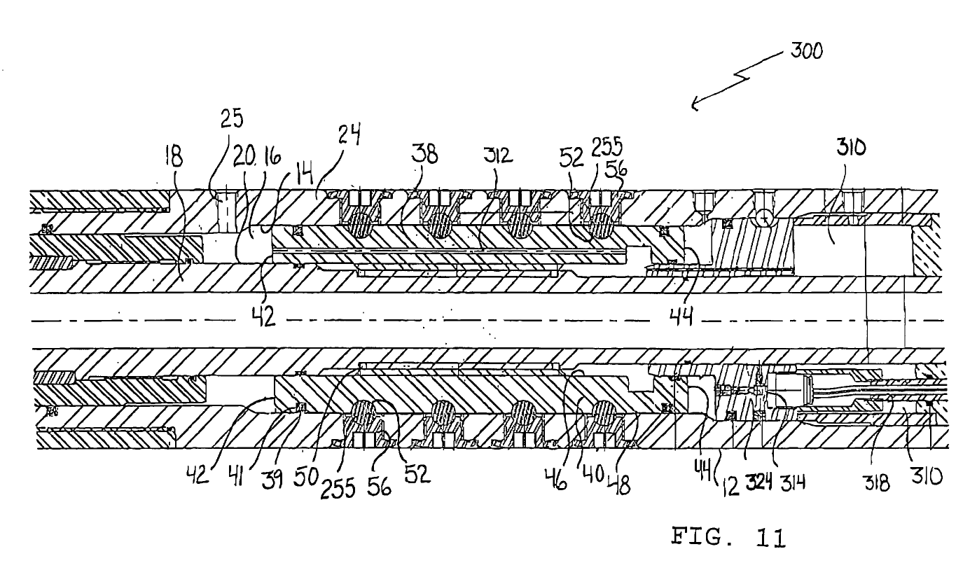

Referring to FIGS. 11 through 13, there is illustrated a second alternative embodiment of an apparatus for controlling a downhole drilling motor assembly, generally referenced by numeral 300. Embodiment 300 differs from the alternative embodiments described above, in manner with which the locking of mandrel 18 in a selected rotational position relative to housing 12 is effected. Referring to FIG. 11, with second alternative embodiment 300, hydraulic dampener assembly 36 includes a hydraulic chamber 310 between mandrel 18 and housing 12. Annular body 38 is disposed within hydraulic chamber 310. A flow passage extends 312 through annular body 38 and annular body 38 is only able to move as hydraulic fluid is displaced via flow passage 312. Movement of annular body 38 in the first direction occurs at a rate determined by the displacement of hydraulic fluid in the second direction and movement of the annular body in the second direction occurs at a rate determined by the displacement of hydraulic fluid in the first direction.

With embodiment 300, an electrically activated valve 314 is provided that controls either directly or indirectly the flow of fluid through flow passage 312. Electrically activated valve 314 serves to indirectly control the flow of hydraulic fluid through flow passage 312, as will hereinafter be further described. Electrically activated valve 314 is movable between an open position allowing a flow of hydraulic fluid through flow passage 312 and a closed position stopping the flow of hydraulic fluid through flow passage 312.

Electrically activated 314 valve is mounted on a stationary flow restricting member 316 that is spaced from second end 44 of annular body 38 and blocks the movement of hydraulic fluid within hydraulic chamber 310. Hydraulic fluid is trapped between annular body 38 and flow restricting member 316 preventing movement of annular body 38 until electrically activated valve 314 is in the open position.

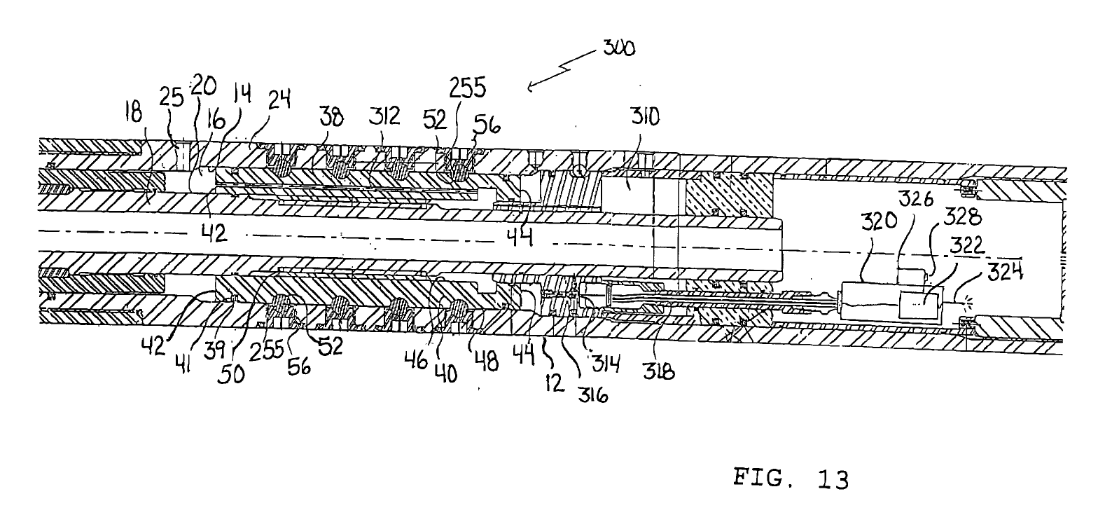

Power for selectively moving electrically activated valve 314 between the open position and the closed position can be supplied by a cable 318 which runs from a power source located at the surface. Referring to FIG. 13, in the alternative, electrically activated valve 314 can have its own source of power provided by a power unit 320. Power unit 320 houses an electrical package 322 including an antenna 324 that is mounted on power unit 320 for the purpose of receiving an activation signal remotely. Power unit 320 can also house a hydraulic cylinder 326 with a pressure sensitive switch 328 which activates in response to pump pressure.

Referring to FIG. 11, electrically activated valve 314 is mounted on stationary flow restricting member 316 so that electrically activated valve 314 will not be subjected to movement with annular body 38. If a wire which makes an electrical connection is subjected to constant movement, the wire tends to fatigue. By mounting electrically activated valve 314 on flow restricting member 316, electrically activated valve 314 can control flow through annular body 38, without moving with annular body 38.

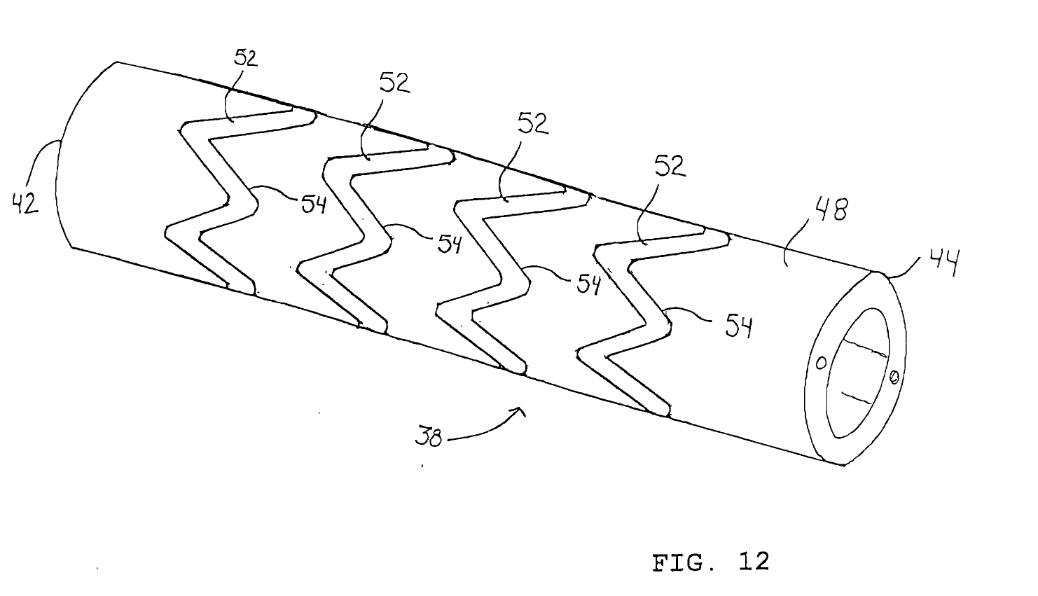

Referring to FIG. 12, another difference illustrated in embodiment 300 is that annular body 38 has a plurality of guide tracks 52. Referring to FIG. 11, guide tracks 52 are adapted to engage with guide members 56 that extending inwardly into interior bore 16 from interior sidewall 14 of housing 12, thereby limiting the rotational movement of annular body 38 relative to housing 12 to zig-zag pattern 54 provided by guide tracks 52 illustrated in FIG. 12. Referring to FIG. 11, in the illustrated embodiment 300, eight guide members 56 are illustrated however 16 can be used. Each of guide members 56 terminate in ball 255, thereby reducing friction between guide members 56 and guide tracks 52.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. An apparatus for controlling a downhole drilling motor assembly, comprising:
a tubular housing having an interior sidewall which defines an interior bore;
a mandrel rotatably mounted within the interior bore of the housing, the mandrel having an exterior surface;
a hydraulic dampener assembly disposed between the interior sidewall of the housing and the exterior surface of the mandrel, the hydraulic dampener assembly limiting the rate of rotation of the mandrel within the housing, thereby providing a preset resistance to reactive torque.

2. The apparatus for controlling a downhole drilling motor assembly as defined in claim 1, wherein the hydraulic dampener assembly includes:
an annular body having a sidewall, a first end, a second end, an interior surface and an exterior surface;
a splined engagement between the interior surface of the annular body and the exterior surface of the mandrel, such that the annular body rotates with the mandrel while being capable of limited axial movement along the mandrel;
a guide track on the exterior surface which encircles the annular body, the guide track alternatively extending in a first direction from the first end toward the second end of the annular body and then in a second direction from the second end toward the first end of the annular body in a zig-zag pattern;
several guide members extending inwardly into the interior bore from the interior surface of the housing, the guide members engaging the guide track on the annular body, thereby limiting rotational movement of the annular body relative to the housing to the zig-zag pattern provided by the guide track;
the annular body being only able to move as hydraulic fluid is displaced, movement of the annular body in the first direction occurring at a rate determined by the displacement of hydraulic fluid in the second direction and movement of the annular body in the second direction occurring at a rate determined by the displacement of hydraulic fluid in the first direction.

3. The apparatus for controlling a downhole drilling motor assembly as defined in claim 2, wherein the hydraulic dampener assembly includes:
a first series of one way hydraulic valves extending through the sidewall between first end and the second end of the annular body through which hydraulic fluid can only pass from the second end to the first end, such that movement in the first direction can only occur at a rate determined by the bleeding of hydraulic fluid through the first series of one way hydraulic valves; and
a second series of one way hydraulic valves extending through the sidewall between the first end and the second end of the annular body through which hydraulic fluid can only pass from the first end to the second end, such that movement in the second direction can only occur at a rate determined by the bleeding of hydraulic fluid through the second series of one way hydraulic valves.

4. The apparatus for controlling a downhole drilling motor assembly as defined in claim 3, wherein means is provided to selectively block the flow of hydraulic fluid simultaneously through both the first series of one way hydraulic valves and the second series of one way hydraulic valves, thereby locking the mandrel in a selected rotational position relative to the housing.

5. The apparatus for controlling a downhole drilling motor assembly as defined in claim 4, wherein the means to selectively block the flow of hydraulic fluid includes an annular plug reciprocally movable along the mandrel between a locking position engaging one of the first end or the second end of the annular body and a release position spaced from the annular body.

6. The apparatus for controlling a downhole drilling motor assembly as defined in claim 4, wherein the means to selectively block the flow of hydraulic fluid includes an electrically activated valve.

7. The apparatus for controlling a downhole drilling motor assembly as defined in claim 2, wherein a clutch is reciprocally movable along the mandrel between a locking position engaging one of the first end or the second end of the annular body and a release position spaced from the annular body.

8. The apparatus for controlling a downhole drilling motor assembly as defined in claim 2, wherein the guide members terminate in balls, thereby reducing friction between the guide members and the guide track.

9. An apparatus for controlling a downhole drilling motor assembly, comprising:
a tubular housing having an interior sidewall which defines an interior bore;
a mandrel rotatably mounted within the interior bore of the housing, the mandrel having an exterior surface;
radial bearings disposed between the interior sidewall of the housing and the exterior surface of the mandrel, thereby transmitting radial loads from the mandrel to the housing;
thrust bearings disposed between the interior sidewall of the housing and the exterior surface of the mandrel, thereby transmitting axial thrust loads from the mandrel to the housing;
seals positioned between the interior sidewall of the housing and the exterior surface of the mandrel to prevent the entry of abrasive drilling fluids into the radial bearings and the thrust bearings;
a hydraulic dampener assembly disposed between the interior sidewall of the housing and the exterior surface of the mandrel, the hydraulic dampener assembly limiting the rate of rotation of the mandrel within the housing, thereby providing a preset resistance to reactive torque, the hydraulic dampener assembly including:
an annular body having a sidewall, a first end, a second end, an interior surface and an exterior surface;
a splined engagement between the interior surface of the annular body and the exterior surface of the mandrel, such that the annular body rotates with the mandrel while being capable of limited axial movement along the mandrel;
a guide track on the exterior surface which encircles the annular body, the guide track alternatively extending in a first direction from the first end toward the second end of the annular body and then in a second direction from the second end toward the first end of the annular body in a zig-zag pattern;
several guide members extending inwardly into the interior bore from the interior surface of the housing, the guide members engaging the guide track on the annular body, thereby limiting rotational movement of the annular body relative to the housing to the zig-zag pattern provided by the guide track;
a first series of one way hydraulic valves extending through the sidewall between first end and the second end of the annular body through which hydraulic fluid can only pass from the second end to the first end, such that movement in the first direction can only occur at a rate determined by the bleeding of hydraulic fluid through the first series of one way hydraulic valves;
second series of one way hydraulic valves extending through the sidewall between the first end and the second end of the annular body through which hydraulic fluid can only pass from the first end to the second end, such that movement in the second direction can only occur at a rate determined by the bleeding of hydraulic fluid through the second series of one way hydraulic valves;
an annular plug reciprocally movable along the mandrel between a locking position engaging one of the first end or the second end of the annular body and a release position spaced from the annular body, in the locking position the annular plug blocking the flow of hydraulic fluid simultaneously through both the first series of one way hydraulic valves and the second series of one way hydraulic valves, thereby locking the mandrel in a selected rotational position relative to the housing; and
a telescopic actuator disposed in the housing, the telescopic actuator being adapted to selectively move the annular plug between the release position and the locking position.

10. An apparatus for controlling a downhole drilling motor assembly, comprising:
a tubular housing having an interior sidewall which defines an interior bore;
a mandrel rotatably mounted within the interior bore of the housing, the mandrel having an exterior surface;
radial bearings disposed between the interior sidewall of the housing and the exterior surface of the mandrel, thereby transmitting radial loads from the mandrel to the housing;
thrust bearings disposed between the interior sidewall of the housing and the exterior surface of the mandrel, thereby transmitting axial thrust loads from the mandrel to the housing;
seals positioned between the interior sidewall of the housing and the exterior surface of the mandrel to prevent the entry of abrasive drilling fluids into the radial bearings and the thrust bearings;
a hydraulic dampener assembly disposed between the interior sidewall of the housing and the exterior surface of the mandrel, the hydraulic dampener assembly limiting the rate of rotation of the mandrel within the housing, thereby providing a preset resistance to reactive torque, the hydraulic dampener assembly including:
an annular body having a sidewall, a first end, a second end, an interior surface and an exterior surface;
a splined engagement between the interior surface of the annular body and the exterior surface of the mandrel, such that the annular body rotates with the mandrel while being capable of limited axial movement along the mandrel;
a guide track on the exterior surface which encircles the annular body, the guide track alternatively extending in a first direction from the first end toward the second end of the annular body and then in a second direction from the second end toward the first end of the annular body in a zig-zag pattern;
several guide members extending inwardly into the interior bore from the interior surface of the housing, the guide members engaging the guide track on the annular body, thereby limiting rotational movement of the annular body relative to the housing to the zig-zag pattern provided by the guide track, the guide members terminating in balls, thereby reducing friction between the guide members and the guide track;
means for bleeding hydraulic fluid past the annular body in a first direction and means for bleeding hydraulic fluid past the annular body in a second direction, relative rotation of the housing and the mandrel can only occurring at a rate determined by the bleeding of hydraulic fluid past the annular body;
a clutch reciprocally movable along the mandrel between a locking position engaging one of the second end of the annular body and a release position spaced from the annular body, in the locking position the clutch engaging the second end of the annular body, thereby locking the mandrel in a selected rotational position relative to the housing; and
a telescopic actuator disposed in the housing, the telescopic actuator being adapted to selectively move the clutch between the release position and the locking position.

11. An apparatus for controlling a downhole drilling motor assembly, comprising;
a tubular housing having an interior sidewall which defines an interior bore;
a mandrel rotatably mounted within the interior bore of the housing, the mandrel having an exterior surface;
radial bearings disposed between the interior sidewall of the housing and the exterior surface of the mandrel, thereby transmitting radial loads from the mandrel to the housing;
thrust bearings disposed between the interior sidewall of the housing and the exterior surface of the mandrel, thereby transmitting axial thrust loads from the mandrel to the housing;
seals positioned between the interior sidewall of the housing and the exterior surface of the mandrel to prevent the entry of abrasive drilling fluids into the radial bearings and the thrust bearings;
a hydraulic dampener assembly disposed between the interior sidewall of the housing and the exterior surface of the mandrel, the hydraulic dampener assembly limiting the rate of rotation of the mandrel within the housing, thereby providing a preset resistance to reactive torque, the hydraulic dampener assembly including:
a hydraulic chamber between the mandrel and the housing;
an annular body having a sidewall, a first end, a second end, an interior surface and an exterior surface;
the annular body being disposed within the hydraulic chamber;
a splined engagement between the interior surface of the annular body and the exterior surface of the mandrel, such that the annular body rotates with the mandrel while being capable of limited axial movement along the mandrel;
a guide track on the exterior surface which encircles the annular body, the guide track alternatively extending in a first direction from the first end toward the second end of the annular body and then in a second direction from the second end toward the first end of the annular body in a zig-zag pattern;
guide members extending inwardly into the interior bore from the interior surface of the housing, the guide members engaging the guide track on the annular body, thereby limiting rotational movement of the annular body relative to the housing to the zig-zag pattern provided by the guide track;
at least one flow passage extending through the annular body, the annular body only being able to move as hydraulic fluid is displaced via the flow passage, movement of the annular body in the first direction occurring at a rate determined by the displacement of hydraulic fluid in the second direction and movement of the annular body in the second direction occurring at a rate determined by the displacement of hydraulic fluid in the first direction;
an electrically activated valve communicating with the flow passage, the electrically activated valve in an open position allowing a flow of hydraulic fluid through the flow passage and when in a closed position stopping the flow of hydraulic fluid through the flow passage;
the electrically activated valve controlling the flow through the flow passage;
means for selectively moving the electrically activated valve between the open position and the closed position.

12. The apparatus for controlling a downhole drilling motor assembly as defined in claim 11, wherein the guide members terminate in balls, thereby reducing friction between the guide members and the guide track.

13. The apparatus for controlling a downhole drilling motor assembly as defined in claim 11, wherein the electrically activated valve is mounted on a stationary flow restricting member that is spaced from one of the first end or the second end of the annular body and blocks the movement of hydraulic fluid within the hydraulic chamber, the hydraulic fluid trapped between the annular body and the flow restricting member preventing movement of the annular body until the electrically activated valve is in the open position.

14. The apparatus for controlling a downhole drilling motor assembly as defined in claim 11, wherein a power source is housed within the housing, the power source activating the electrically activated valve in response a signal transmitted from surface.

15. The apparatus for controlling a downhole drilling motor assembly as defined in claim 14, wherein means is provided for turning power to the electrically activated valve on and off in response to pump pressure.

16. The apparatus for controlling a downhole drilling motor assembly as defined in claim 15, wherein the means for turning power to the electrically activated valve on and off in response to pump pressure is a pressure switch.

17. The apparatus for controlling a downhole drilling motor assembly as defined in claim 14, wherein a receiver is linked to the power source, whereby signals are transmitter to the receiver from surface to provided for turning power to the electrically activated valve on and off.
